(19) United States
(12) Patent Application Publication
(10) Pub. No.: US 2009/0037007 A1
(43) Pub. Date: Feb. 5, 2009

(54) GUIDANCE REPORT DEVICE, GUIDANCE REPORT INTEGRATED CIRCUIT, GUIDANCE REPORT METHOD, AND GUIDANCE REPORT PROGRAM

(75) Inventor: Hirofumi Nishimura, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/995,889

(22) PCT Filed: Jul. 26, 2006
(86) PCT No.: PCT/JP2006/314719

§ 371 Date: Jan. 16, 2008

(30) Foreign Application Priority Data
Jul. 27, 2005 (JP) 2005-216739

(51) Int. Cl. G06F 17/00

(52) U.S. Cl. 700/94

(57) ABSTRACT

A guidance issuing device has a guidance sound storage unit for storing a guidance sound set every guidance, a sound volume setting unit for setting the volume of the guidance sound, a sound volume storage unit for storing the volume set by the sound volume setting unit, and an output unit for outputting the guidance sound at the set volume level corresponding to the guidance sound of the sound volume storage unit.

### TECHNICAL FIELD

The present invention relates to a guidance issuing device having a function of issuing guidance.

### BACKGROUND ART

Conventionally, an information apparatus and electrical apparatus having a function of issuing guidance have a guidance issuing device. The guidance issuing device has a switch voice issuing function, an alarm voice issuing function, a stopwatch voice issuing function, a timer voice issuing function, an auto-speak voice issuing function in order to issue the guidance while controlling it to an appropriate sound volume. A guidance issuing device allowing the sound volume to be set to each function is disclosed by Japanese Patent Unexamined Publication No. H1-158385 (Patent document 1), for example. A device for storing the importance of the guidance, determining the importance of the guidance to be issued, and issuing the guidance in an output state corresponding to the importance of the guidance is disclosed by Japanese Patent Unexamined Publication No. H11-53167 (Patent document 2), for example.

In the technology disclosed by Patent document 1, it is difficult for an unskilled user who does not clearly know the originally provided functions to functionally classify guidance showing the function of the electrical apparatus and its operation guide or guidance showing the various states of the electrical apparatus and to control the sound volume of the guidance. Here, the unskilled user corresponds to a user who just begins using the electrical apparatus or a user who is no good at operation of the electrical apparatus.

Users who are accustomed to using the electrical apparatus do not obtain improved convenience even when all guidance of the electrical apparatus is issued.

For instance, a kerosene fan heater has a plurality of kinds of guidance for announcing the residue of kerosene, such as guidance for announcing that the quantity of the kerosene becomes small and guidance for announcing that the kerosene completely runs out and the operation is instantly stopped.

A bath water heater has a plurality of kinds of guidance for announcing the water heating states, such as guidance for announcing that the water heating will be completed after several minutes and guidance for announcing that the water heating has been completed.

Thus, some users feel guidance to be necessary and other users feel the guidance to be unnecessary even when the guidance has the same function. Uncomfortable feeling due to guidance that is not required by a user cannot be reduced only by controlling the announcing method of each function.

In the technology disclosed by Patent document 2, the volume of a guidance sound is controlled in response to the importance. However, the importance of the guidance depends on user's familiarity with the electrical apparatus. Therefore, uncomfortable feeling due to guidance that is not required by a user cannot be reduced.

### SUMMARY OF THE INVENTION

The present invention addresses the conventional problems, and provides a guidance issuing device or the like that allows a user to easily change the issuing method of guidance about which a user feels necessary or unnecessary.

A guidance issuing device of the present invention has the following elements:
a guidance sound storage unit for storing a guidance sound set every guidance;
a sound volume setting unit for setting the volume of the guidance sound;
a sound volume storage unit for storing the volume set by the sound volume setting unit; and
an output unit for outputting the guidance sound at a set volume level corresponding to the guidance sound of the sound volume storage unit.

Thanks to this structure, sound volume can be set not to the function to be guided or the importance of the guidance, but to each guidance sound itself, and only the necessary guidance can be issued at an appropriate volume level.

In the guidance issuing device of the present invention, when the output unit continuously outputs a plurality of guidance sounds whose volumes are set by the sound volume setting unit, it preferably outputs the plurality of guidance sounds at a set volume level corresponding to one guidance sound set by the sound volume setting unit, among the plurality of guidance sounds.

In this structure, when guidance is constituted by a plurality of guidance sounds, the sound volume of the guidance itself can be set and the number of set sound volumes can be reduced by setting the volume of one guidance sound.

The guidance issuing device of the present invention preferably includes a last-minute guidance sound storage unit for storing a guidance sound to be output and a last-minute guidance-sound set-volume changing unit for changing the set sound volume that corresponds to the output guidance sound to be stored in the sound volume storage unit.

This structure allows the set sound volume to be changed without troublesomely checking the last output guidance.

In the guidance issuing device of the present invention, preferably, the sound volume storage unit stores a digitized set sound volume, the last-minute guidance-sound set-volume changing unit has a switch for changing the set sound volume, and the digitized set sound volume is changed with the switch.

In this structure, the digitized set volume having some levels can be easily changed only by operating the switch.

In the guidance issuing device of the present invention, preferably, the last-minute guidance-sound set-volume changing unit has a rotary switch for changing the volume of a guidance sound supplied from the output unit, and changes the set sound volume in the sound volume storage unit when the rotary switch is operated within a predetermined time of supply of the guidance sound.

In this structure, the guidance issuing device does not require an additional switch for changing the set volume of a guidance sound.

In the guidance issuing device of the present invention, preferably, the sound volume set by the sound volume setting unit is not changed when the last-minute guidance-sound set-volume changing unit is continuously operated within a predetermined time.

In this structure, the continuous operation can provide a function other than volume change.

In the guidance issuing device of the present invention, preferably, a guidance sound is output at a set volume level when the last-minute guidance-sound set-volume changing unit is operated during output of the guidance sound.

In this structure, the set volume of the guidance sound can be changed and a user can hear and check it before the completion of the output of the guidance sound.

An integrated circuit for issuing guidance of the present invention has the following elements:
a guidance sound storage unit for storing a guidance sound set every guidance;
a sound volume setting unit for setting the volume of the guidance sound;
a sound volume storage unit for storing the volume set by the sound volume setting unit; and
a last-minute guidance sound storage unit for storing a guidance sound to be output.
   The guidance issuing device outputs, using an output unit, a guidance sound at a set volume level corresponding to the guidance sound stored in the sound volume storage unit. The guidance issuing device changes the set volume corresponding to the output guidance sound stored in the guidance sound storage unit using a last-minute guidance-sound set-volume changing unit.

In this structure, the volume of each guidance sound itself is set or changed based on the guidance output the last time, and only the required guidance can be issued at an appropriate volume level.

A guidance issuing method of the present invention has the following steps:
a guidance sound storing step of storing a guidance sound set every guidance;
a sound volume setting step of setting the volume of the guidance sound; a sound volume storing step of storing the volume set in the sound volume setting step;
an output step of outputting the guidance sound at a set volume level corresponding to the guidance sound stored in the sound volume setting step;
a last-minute guidance sound storing step of storing the output guidance sound; and
a last-minute guidance-sound set-volume changing step of changing the set volume corresponding to the output guidance sound stored in the sound volume storing step.

In this structure, the volume of each guidance sound itself is set or changed based on the guidance output the last time, and only the required guidance can be issued at an appropriate volume level.

A program of issuing guidance of the present invention has the following steps:
a guidance sound storing step of storing a guidance sound set every guidance;
a sound volume setting step of setting the volume of the guidance sound;
a sound volume storing step of storing the volume set in the sound volume setting step;
an output step of outputting the guidance sound at a set volume level corresponding to the guidance sound stored in the sound volume setting step;
a last-minute guidance sound storing step of storing the output guidance sound; and
a last-minute guidance-sound set-volume changing step of changing the set volume corresponding to the output guidance sound stored in the sound volume storing step.

In this structure, the volume of each guidance sound itself is set or changed based on the guidance output the last time, and only required guidance can be issued at an appropriate volume level.

### BRIEF DESCRIPTION OF DRAWINGS

FIG. 1 is a block diagram showing the structure of a guidance issuing device in accordance with a first exemplary embodiment of the present invention.

FIG. 2 illustrates the contents of a voice data file of the guidance issuing device in accordance with the first exemplary embodiment.

FIG. 3 illustrates the contents of a set volume data file of the guidance issuing device in accordance with the first exemplary embodiment.

FIG. 4 is a flowchart showing an operation procedure of issuing guidance in a guidance issuing method in accordance with a second exemplary embodiment of the present invention.

FIG. 5 is a flowchart showing an operation procedure of adjusting the sound volume in the guidance issuing method in accordance with the second exemplary embodiment.

### REFERENCE MARKS IN THE DRAWINGS

1 guidance sound storage unit
2 guidance sound control unit
3 guidance sound output unit
4 guidance sound volume storage unit
5 last-minute guidance sound storage unit
6 sound volume setting unit
7 last-minute guidance-sound set-volume changing unit

### DETAILED DESCRIPTION OF PREFERRED EMBODIMENTS

A guidance issuing device and guidance issuing method capable of categorizing the setting of the existence, volume, or the like of a guidance sound every user will be described.

In the first and second exemplary embodiments described hereinafter, guidance can be issued by outputting one or more guidance sounds.

### First Exemplary Embodiment

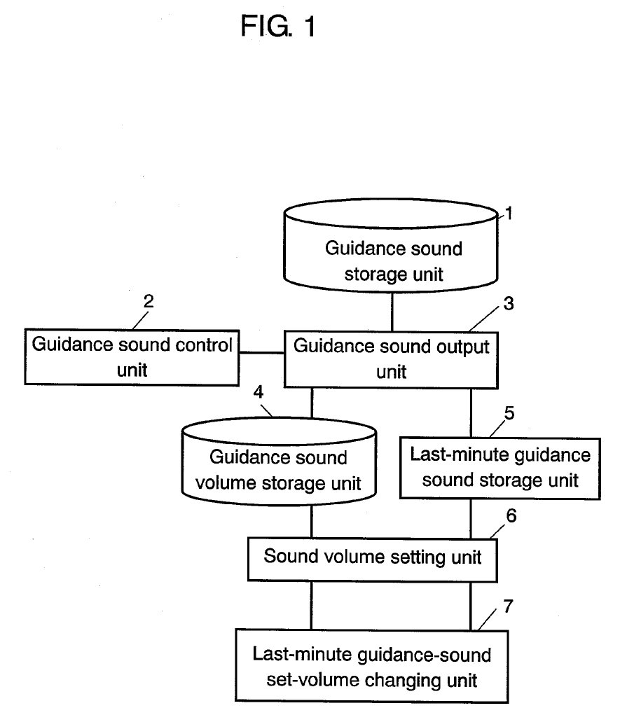

In the first exemplary embodiment, one aspect of the guidance issuing device of the present invention will be described hereinafter with reference to FIG. 1 through FIG. 3.

When an electrical apparatus performs guidance of the operation state, operation guide, or operation check, the guidance about which each user (or one user) feels necessary or convenient depends on the user's familiarity with the electrical apparatus.

Thus, preferably, the issuing contents and issuing method of each of various kinds of guidance about which a user feels necessary or unnecessary are appropriately controlled, and the uncomfortable feeling due to the unnecessary guidance can be reduced.

FIG. 1 is a block diagram showing the structure of a guidance issuing device in accordance with the first exemplary embodiment of the present invention.

The guidance issuing device of the first exemplary embodiment has the following elements:
guidance sound storage unit 1;
guidance sound control unit 2;
guidance sound output unit 3;
guidance sound volume storage unit 4;
last-minute guidance sound storage unit 5;
sound volume setting unit 6; and
last-minute guidance-sound set-volume changing unit 7.
   All of these elements are organically associated with each other to form a guidance issuing function.

Guidance sound storage unit 1 stores a part or all of the guidance sounds constituting guidance. Guidance sound control unit 2 determines which guidance sound is output with which timing, when the guidance of the operation procedure, operation check, operation state, or operation completion is issued. Guidance sound output unit 3 extracts the guidance sound determined by guidance sound control unit 2 from guidance sound storage unit 1, and outputs the guidance sound at the set volume level. Guidance sound volume storage unit 4 stores the set volume of each guidance sound. Last-minute guidance sound storage unit 5 stores the identification (ID) of the guidance sound supplied from guidance sound output unit 3 the last time. Sound volume setting unit 6 investigates the ID of the last output guidance sound in last-minute guidance sound storage unit 5, and changes the set volume of the guidance sound. Last-minute guidance-sound set-volume changing unit 7 is an interface with which a user can set a guidance sound.

Guidance sound storage unit 1 is formed of a nonvolatile semiconductor memory, for example, and stores sound data supplied as a guidance sound. When electron sound “pipipi” is used as the guidance sound, the frequency or rhythm pattern may be stored. When a melody is output as the guidance sound, musical score or music tempo required for outputting the melody may be stored. Additionally, when guidance sound output unit 3 has a Text-To-Speech function, a text output as the guidance sound may be stored.

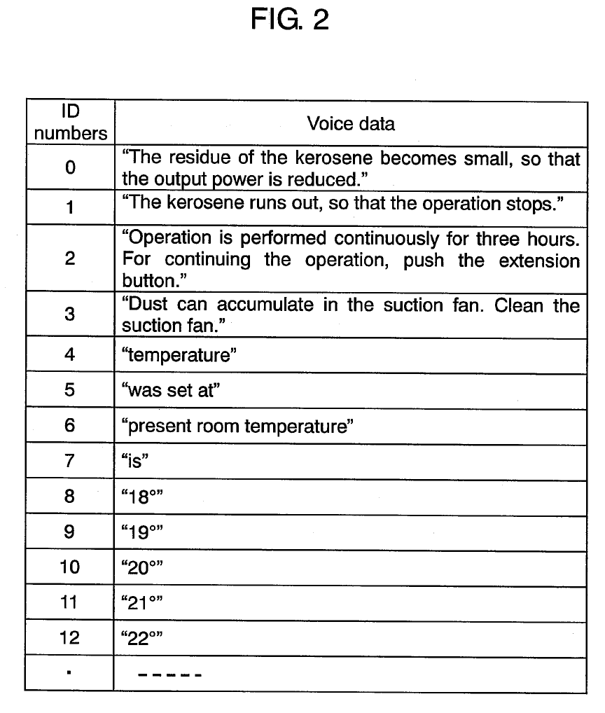

FIG. 2 illustrates the contents of a voice data file stored by guidance sound storage unit 1. FIG. 2 shows the case where a voice is used as the guidance sound in a kerosene fan heater. An ID number is assigned to each guidance sound. The guidance sound may be a full sentence such as ID number 0 through ID number 3, or may be part of a sentence such as ID number 4 through ID number 12.

Guidance sound control unit 2 checks the state of the electrical apparatus, selects the guidance sound to be output, and controls the output timing. In the example of the kerosene fan heater, the operation state is varied in response to the residue of the kerosene, and the state is announced with guidance. When it is determined that the residue of the kerosene becomes small and continuing the operation causes the kerosene to run out in a short time, operation with low output power is started. At this time, guidance sound control unit 2 detects the determination timing, and selects, as the guidance sound to be output, guidance sound “The residue of the kerosene becomes small, so that the output power is reduced” of ID number 0 of FIG. 2.

When the operation is continued without refilling, the kerosene runs out and the operation stops. Then, guidance sound control unit 2 detects the stop timing, and selects guidance sound “The kerosene runs out, so that the operation stops” of ID number 1 of FIG. 2.

Next, the case where guidance of operation check is issued when the set temperature is varied is described. Guidance sound control unit 2 selects guidance sounds “temperature” of ID number 4, “was set at” of ID number 5, and “19°” of ID number 9 corresponding to the set temperature, for example, in FIG. 2. Thus, guidance “Temperature was set at 19°” is issued.

Next, an example of a bath water heater announcing a water heating state is described. When the control is performed so that the guidance showing five minutes before the completion of the water heating and the guidance showing the completion of the water heating are issued, guidance sound control unit 2 detects the timing of five minutes before the completion of the water heating and the timing of the completion of the water heating, and selects guidance sounds “Bath will be heated after five minutes” and “Bath was heated,” respectively.

Next, an example is described where right turn or left turn at an intersection is guided 700 m and 300 m before the intersection using a car navigation system. Guidance sound control unit 2 detects the timings of arrival at 700 m and 300 m before the intersection, and selects guidance sounds “Turn right after about 700 m” and “Turn right after about 300 m,” respectively.

Guidance sound output unit 3 previously has an amplifier so as to control the sound volume. The amplifier is structured so as to digitally multiply the guidance sound that is digitized and stored in guidance sound storage unit 1 by the gain equivalent to the set sound volume stored in guidance sound volume storage unit 4 and so as to vary the amplitude of the voice data.

When the lowest volume level of the guidance sound about which a user feels unnecessary is set in guidance sound volume storage unit 4, the lowest volume level may be set silent or may be simply a level at which the user does not feel uncomfortable. When the voice data stored in guidance sound storage unit 1 is compressed by a codec or the like, a decoder function of decoding the compressed data to the voice data may be installed in guidance sound output unit 3. At this time, the multiplying processing of varying the amplitude or the decoding processing of the compressed voice data may be performed using another generally-controlled arithmetic device included in the electrical apparatus, or using dedicated hardware. Guidance sound output unit 3 may have not only the amplifier but also a digital/analog (D/A) converter and speaker.

When an electron sound is used for a guidance sound, an oscillation element may be disposed in guidance sound output unit 3, and may output an electron sound of an arbitrary frequency. When a buzzer is used for a guidance sound, guidance sound output unit 3 may have the buzzer whose sound volume can be controlled. Text is previously stored in guidance sound storage unit 1, and, guidance sound output unit 3 may have a Text-To-Speech function and may output the guidance sound using a Text-To-Speech technology.

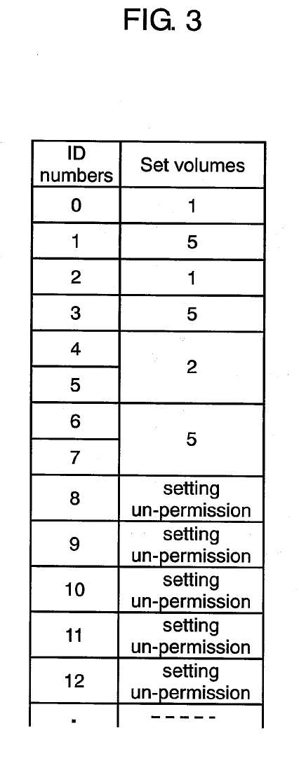

As guidance sound volume storage unit 4, a nonvolatile semiconductor memory can be used, for example. FIG. 3 illustrates the contents of a set volume data file stored in the guidance sound volume storage unit, and the contents correspond to the guidance sounds of FIG. 2.

In the data of FIG. 3, the set volume is divided into five stages 1 through 5, stage 5 shows the maximum volume, and stage 1 shows the minimum volume. Each of the guidance sounds of ID number 0 through ID number 3 corresponds to one kind of guidance, so that a sound volume can be set to each guidance sound. The guidance sounds of ID number 4 and ID number 5, or the guidance sounds of ID number 6 and ID number 7 are always used simultaneously. One of the guidance sounds of ID number 8 through ID number 12 is inserted between the guidance sounds of ID number 4 and ID number 5, or between the guidance sounds of ID number 6 and ID number 7, and resultant guidance is output. Thus, when one kind of guidance is constituted by a plurality of guidance sounds, it is designed so that a sound volume can be set only to the guidance sound including common contents in the guidance and the same sound volume can be set to simultaneously used guidance sounds.

When guidance is issued using a guidance sound whose volume cannot be set, it is recommended that this guidance sound is output at the volume level of the guidance sound that is simultaneously output by guidance sound output unit 3.

All set sound volumes may be set at 5 as the initial state of the electrical apparatus before shipping from the factory, all guidance sounds may be output initially at a large volume level to allow a user to recognize which guidance sounds are included in the electrical apparatus. A mode switching function between a beginner and a skilled person may be disposed, and the volumes of guidance sounds may be set in a lump.

A flag column of setting permission or setting un-permission may be added to the data table of FIG. 3, last-minute guidance-sound set-volume changing unit 7 may be allowed to set only the volume of a guidance sound of setting permission, and a flag of setting un-permission may be applied to a guidance sound for warning of danger to inhibit the reduction of the volume.

As last-minute guidance sound storage unit 5, a semiconductor memory can be used, for example. Last-minute guidance sound storage unit 5 stores the ID number of a guidance sound just before guidance sound output unit 3 outputs the guidance sound. When guidance is constituted by a plurality of guidance sounds such as ID number 4 and ID number 5 of FIG. 3, the ID number of one of the guidance sounds to which sound volumes can be set is previously stored. In the first embodiment, the last guidance sound is stored using the ID number. When the guidance sound itself is stored, a similar function can be achieved without using the ID number.

Last-minute guidance-sound set-volume changing unit 7 is formed of two push button switches of “large volume” and “small volume”, for example. When the push button switch of “large volume” is operated, using sound volume setting unit 6, the ID number of the guidance sound stored in last-minute guidance sound storage unit 5 is checked, the set volume of the corresponding guidance sound stored in guidance sound volume storage unit 4 is checked, and the set volume is set again to be large. At this time, the set volume, which is set at any one of five stages, is increased by one stage. When the original set volume lies in stage 5, the set volume is not changed. Similarly, when the push button switch of “small volume” is operated, the set volume is decreased. When the original set volume lies in stage 1, the set volume is not changed.

When the volume is set again, the guidance sound is output at the level of the set volume. Thus, a user easily recognizes the guidance whose volume has been set again. When last-minute guidance-sound set-volume changing unit 7 is continuously operated, for example, when the second and later operations are performed within three seconds of the first operation, the volume setting operation is not performed in the first operation and the last guidance sound may be output at the present set volume level in the second and later operations. In this process, last-minute guidance-sound set-volume changing unit 7 can be used also as a switch of simple re-output.

When last-minute guidance-sound set-volume changing unit 7 is operated while the electrical apparatus outputs a guidance sound, the re-output is not required and hence a new sound volume is instantly set in guidance sound volume storage unit 4. At this time, the guidance sound may be output while the volume is changed midway, or may be output from the start at a volume level set again.

When the electrical apparatus is an acoustic apparatus such as a compact disk (CD) player or television (TV), the rotary volume switch for adjusting the sound volume may be changed in response to the mode, and may be used as last-minute guidance-sound set-volume changing unit 7. When the volume switch of the acoustic apparatus is operated within five seconds of the output of a guidance sound, for example, the volume switch is used as last-minute guidance-sound set-volume changing unit 7 and the processing of changing the set volume is performed. The sound volume of the acoustic apparatus may be used as the sound volume of the guidance.

In other words, the guidance issuing device of the first exemplary embodiment has a storage unit of the set volume of each guidance sound and a setting unit capable of individually setting the volume of the last output guidance sound, so that the volume of each guidance sound can be easily changed. As a result, when the user feels unnecessary about each kind of guidance, the user can set the sound volume of the guidance to be small. Therefore, uncomfortable feeling due to the unnecessary guidance can be reduced.

In the example of the kerosene fan heater, when both of guidance sound “The residue of the kerosene becomes small, so that the output power is reduced” and guidance sound “The kerosene runs out, so that the operation stops” are required, both guidance sounds are used as they are. When one of guidance sounds is not required, the volume of the unnecessary guidance sound is reduced and hence the uncomfortable feeling due to the unnecessary guidance can be reduced.

In the example of the bath water heater, similarly, the volume of the unnecessary guidance sound, of guidance sounds “Bath will be heated after five minutes” and “Bath was heated,” can be easily reduced.

In the example of the car navigation system, the volume of the unnecessary guidance sound, of guidance sounds “Turn right after about 700 m” and “Turn right after about 300 m,” can be easily reduced.

The guidance issuing device of the first exemplary embodiment can categorize the setting of existence or volume of guidance sounds for each user, even in an electrical apparatus where guidance sounds are set correspondingly to all operations and a user cannot recognize the all guidance sounds. Therefore, the uncomfortable feeling due to the output of the guidance sound about which the user feels unnecessary can be reduced.

In the first exemplary embodiment, when guidance sound output unit 3 has a switch for mode change and volume change so as to set a volume to each guidance sound, for example, last-minute guidance sound storage unit 5, sound volume setting unit 6, and last-minute guidance-sound set-volume changing unit 7 are not required.

In the first exemplary embodiment, guidance sound output unit 3 receives a command from guidance sound control unit 2 and operates. However, a unit other than guidance sound output unit 3 may receive the command, or each unit may receive it individually and operate.

### Second Exemplary Embodiment

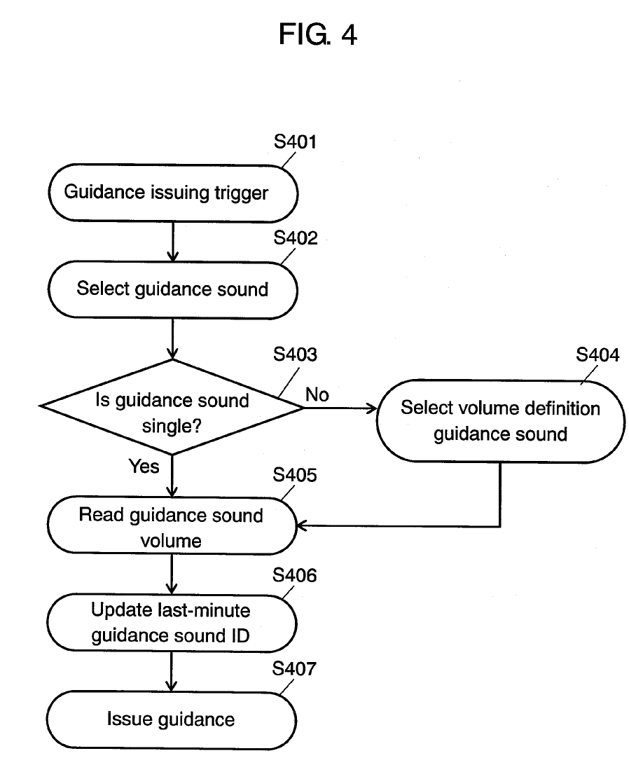

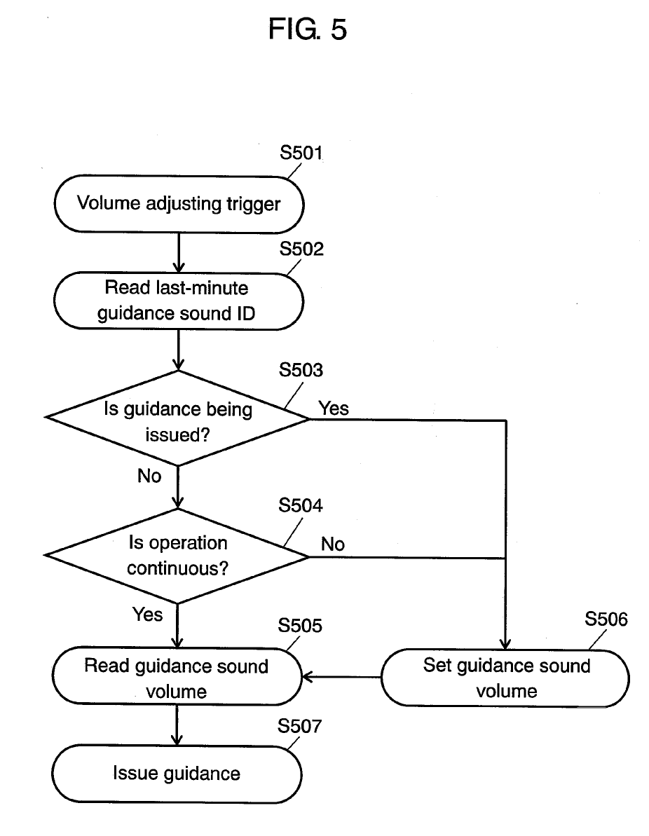

In the second exemplary embodiment, one aspect of the guidance issuing method of the present invention will be described hereinafter with reference to FIG. 4 and FIG. 5.

In the second exemplary embodiment, a guidance issuing method that produces an advantage similar to that of the guidance issuing device of the first exemplary embodiment is described according to the processing procedure of each component of the guidance issuing device.

FIG. 4 and FIG. 5 are flowcharts showing operation procedures of the guidance issuing method of the second exemplary embodiment. FIG. 4 is a flowchart showing an operation procedure when an electrical apparatus issues guidance. FIG. 5 is a flowchart showing an operation procedure when a user adjusts the sound volume.

First, the operation procedure when an electrical apparatus issues guidance is described with reference to FIG. 4. Specifically, the example of the kerosene fan heater having been described in first exemplary embodiment is used.

When the kerosene fan heater issues guidance of the operation state, operation guide, or operation check, a guidance issuing trigger starts (step S401). When the guidance issuing trigger starts, all necessary guidance sounds are selected by guidance sound selecting processing (step S402). When guidance is constituted by one guidance sound, the ID number of one corresponding guidance sound is selected. When guidance is constituted by a plurality of guidance sounds, all of the ID numbers of necessary guidance sounds are selected. When guidance “The residue of the kerosene becomes small, so that the output power is reduced” shown as the voice data file in FIG. 2 is issued, only ID number 0 is selected as the guidance sound. When guidance “temperature”, “was set at”, and “20°” is issued, ID numbers 4, 5 and 10 are selected and the guidance sounds are output.

Next, it is determined by plural/single determination whether guidance is constituted by a plurality of guidance sounds or a single guidance sound. Guidance “The residue of the kerosene becomes small, so that the output power is reduced” is determined to be constituted by a single guidance sound. Guidance “temperature”, “was set at”, and “20°” is determined to be constituted by a plurality of guidance sounds. When plurality is determined (“No” in step S403), the process goes to volume definition guidance-sound selecting processing. When single is determined (“Yes” in step S403), the process goes to guidance sound volume reading processing.

When the number of guidance sounds is plurality and the process goes to volume definition guidance-sound selecting processing, the ID number of the guidance sound whose volume is defined is retrieved from the plurality of guidance sounds (step S404). Here, the data in guidance sound volume storage unit 4 of FIG. 3 is checked. The guidance sounds required for guidance “temperature”, “was set at”, and “20°” correspond to ID numbers 4, 5 and 10. A common volume is set to ID number 4 and ID number 5, and no volume is set to ID number 10. Therefore, the volume of one of ID number 4 and ID number 5 is selected here. At this time, only a common volume is set to guidance sounds used simultaneously. Therefore, the volume of ID number 4 or that of ID number 5, whichever volume is selected, the volumes of the guidance sounds are the same. A case where ID number 4 is selected is described hereinafter.

Whichever volume is determined by plural/single determination (step S403), the process goes to the guidance sound volume reading processing. In the guidance sound volume reading processing, the volume set individually every voice data is read (step S405). Here, the individual volume stored in guidance sound volume storage unit 4 shown in FIG. 3 is checked. When the guidance is “The residue of the kerosene becomes small, so that the output power is reduced”, set volume 1 of ID number 0 is read. When the guidance is “temperature”, “was set at”, and “20°”, set volume 2 of ID number 4 determined by the volume definition guidance sound selecting processing (step S404) is read.

Next, the IDs of the guidance sounds are updated by last-minute guidance sound ID updating processing (step S406). When the guidance is “The residue of the kerosene becomes small, so that the output power is reduced”, the ID is updated to ID number 0. While, when the guidance is “temperature”, “was set at”, and “20°”, the ID is updated to ID number 4 determined by the volume definition guidance-sound selecting processing (step S404). At this time, ID number 10 of the voice data “20°” and ID number 5 corresponding to the voice data “was set at” that is always used together with “temperature” are accessorily stored.

Finally, the guidance is issued by guidance issuing processing (step S407). At this time, the guidance is issued at the level of the volume read by the previous guidance sound volume reading processing (step S405). When guidance “The residue of the kerosene becomes small, so that the output power is reduced” is issued, the voice data of ID number 0 is output at the level of volume 1. When guidance “temperature”, “was set at”, and “20°” is issued, the voice data of ID numbers 4, 5 and 10 is output at the level of volume 2.

Next, the operation procedure when a user adjusts the sound volume is described with reference to FIG. 5. Specifically, the example of the kerosene fan heater is used.

When the user operates a switch for volume adjustment, a volume adjusting trigger starts (step S501).

When the volume adjusting trigger starts, the process goes to last-minute guidance sound ID reading processing. In the last-minute guidance-sound ID reading processing, the ID number of the voice data stored in last-minute guidance sound storage unit 5 is read (step S502).

Then, the process goes to under-issuing/completion determining processing, and the issuing state of guidance is checked at the present time. At this time, when the guidance is being issued, the under-issuing is determined simply. When nothing is issued, the completion is determined (step S503).

When the completion is determined in the under-issuing/completion determining processing (“No” in step S503), the process goes to single/continuous operation determining processing. When the switch for volume adjustment is operated continuously within three seconds, the continuous operation is determined. In the other cases, the single operation is determined (step S504).

When the under-issuing is determined in the under-issuing/completion determining processing (“Yes” in step S503), and when the single operation is determined in the single/continuous operation determining processing (“No” in step S504), the process goes to guidance sound volume setting processing. In the guidance sound volume setting processing, the volume stored individually every guidance sound in guidance sound volume storage unit 4 is changed (step S506). When the last issued guidance is “The residue of the kerosene becomes small, so that the output power is reduced”, ID number 0 is stored as the last guidance sound, and hence the set volume of ID number 0 of guidance sound volume storage unit 4 is increased or decreased by one level. When the data of FIG. 3 is stored in guidance sound volume storage unit 4, the level of each volume is changed from 1 to 2 when “large volume” is operated. When “small volume” is operated, the level of the volume is not changed because the minimum of the volume level is 1. Similarly, when guidance “temperature”, “was set at”, and “20°” is issued as the last guidance, ID number 4 is stored as the last guidance sound and hence the set volume corresponding to ID number 4 in guidance sound volume storage unit 4 is increased or decreased by one level.

When the continuous operation is determined in the single/continuous operation determining processing (“Yes” in step S504), and when the guidance sound volume setting processing is performed (step S506), the process goes to the guidance sound volume reading processing. Here, the set volume stored in guidance sound volume storage unit 4 is read. When the guidance is “The residue of the kerosene becomes small, so that the output power is reduced”, the set volume of ID number 0 is read. When the guidance is “temperature”, “was set at”, and “20°”, the set volume of ID number 4 is read (step S505).

Finally, in the guidance issuing processing, the guidance is issued at the level of the volume read by the guidance sound volume reading processing (step S507).

The processing based on such an operation flow can achieve the guidance issuing method capable of adjusting the volume of each guidance sound. When the guidance is being issued, the sound volume of the guidance under issuing can be instantly changed. When some time elapses after issuing of the guidance, the switch for volume adjustment can be operated as a re-output function.

In the guidance issuing method of the second exemplary embodiment, a guidance sound is set to each of all operations, the setting of existence or volume of guidance sounds can be categorized for each user even in an electrical apparatus where all guidance sounds cannot be recognized by the user. Therefore, the uncomfortable feeling due to the guidance sound about which the user feels unnecessary can be reduced.

In the second exemplary embodiment, the case where voice data is stored as the guidance sound in guidance sound storage unit 1 has been described. However, when an electron sound is used, the frequency or rhythm may be stored as information required for transmitting the electron sound. When the Text-To-Speech technology is used, the text data may be stored. The combination of them may be used.

In the first and second exemplary embodiments, a guidance issuing device and a guidance issuing method have been described. However, for obtaining the same advantage as the guidance issuing device, a program for organically operating the components and making a computer execute the guidance issuing method can be considered.

For obtaining the same advantage as the guidance issuing device, an integrated circuit for organically operating the components and executing the guidance issuing method can be also considered.

### INDUSTRIAL APPLICABILITY

The guidance issuing device and guidance issuing method of the present invention can individually set volumes of guidance sounds, and are useful for all electrical apparatuses for issuing guidance. They can be applied to an information apparatus such as a personal computer or personal digital assistant (PDA), or a household electrical appliance.

1. A guidance issuing device comprising:
a guidance sound storage unit for storing a guidance sound set every guidance;
a sound volume setting unit for setting a volume of the guidance sound;
a sound volume storage unit for storing the volume set by the sound volume setting unit; and
an output unit for outputting the guidance sound at the set volume level corresponding to the guidance sound of the sound volume storage unit.

2. The guidance issuing device of claim 1, wherein
when the output unit continuously outputs a plurality of guidance sounds whose volumes are set by the sound volume setting unit, the output unit outputs the plurality of guidance sounds at a set volume level corresponding to one guidance sound set by the sound volume setting unit, among the plurality of guidance sounds.

3. The guidance issuing device of claim 1, further comprising:
a last-minute guidance sound storage unit for storing a guidance sound to be output; and
a last-minute guidance-sound set-volume changing unit for changing a set sound volume corresponding to the output guidance sound stored in the sound volume storage unit.

4. The guidance issuing device of claim 3, wherein
the sound volume storage unit stores a set sound volume to be digitized,
the last-minute guidance-sound set-volume changing unit has a switch for changing a set sound volume, and
the switch changes the digitized set sound volume.

5. The guidance issuing device of claim 3, wherein
the last-minute guidance-sound set-volume changing unit has a rotary switch for changing a volume of a guidance sound supplied from the output unit, and changes a set sound volume in the sound volume storage unit when the rotary switch is operated within a predetermined time of the supply of the guidance sound.

6. The guidance issuing device of claim 3, wherein
when the last-minute guidance-sound set-volume changing unit is continuously operated within a predetermined time, a sound volume set by the sound volume setting unit is not changed.

7. The guidance issuing device of claim 4, wherein
when the last-minute guidance-sound set-volume changing unit is continuously operated within a predetermined time, a sound volume set by the sound volume setting unit is not changed.

8. The guidance issuing device of claim 5, wherein
when the last-minute guidance-sound set-volume changing unit is continuously operated within a predetermined time, a sound volume set by the sound volume setting unit is not changed.

9. The guidance issuing device of claim 3, wherein
when the last-minute guidance-sound set-volume changing unit is operated during output of the guidance sound, the guidance sound is output at a set volume level.

10. The guidance issuing device of claim 4, wherein
when the last-minute guidance-sound set-volume changing unit is operated during output of the guidance sound, the guidance sound is output at a set volume level.

11. The guidance issuing device of claim 5, wherein
when the last-minute guidance-sound set-volume changing unit is operated during output of the guidance sound, the guidance sound is output at a set volume level.

12. An integrated circuit for issuing guidance comprising:
a guidance sound storage unit for storing a guidance sound set every guidance;
a sound volume setting unit for setting a volume of the guidance sound;
a sound volume storage unit for storing the volume set by the sound volume setting unit;
a last-minute guidance sound storage unit for storing a guidance sound to be output; and
a last-minute guidance-sound set-volume changing unit for changing the set volume,
wherein the guidance sound is supplied from an output unit at a set volume level corresponding to the guidance sound stored in the sound volume storage unit, and
wherein a set volume corresponding to the output guidance sound stored in the sound volume storage unit can be changed using the last-minute guidance-sound set-volume changing unit.

13. A guidance issuing method comprising:
a guidance sound storing step of storing a guidance sound set every guidance;
a sound volume setting step of setting a volume of the guidance sound;
a sound volume storing step of storing the volume set in the sound volume setting step;
an output step of outputting the guidance sound at a set volume level corresponding to the guidance sound stored in the sound volume setting step;
a last-minute guidance sound storing step of storing the output guidance sound; and
a last-minute guidance-sound set-volume changing step of changing a set volume corresponding to the output guidance sound stored in the sound volume storing step.

14. A program of issuing guidance comprising:
a guidance sound storing step of storing a guidance sound set every guidance;
a sound volume setting step of setting a volume of the guidance sound;
a sound volume storing step of storing the volume set in the sound volume setting step;
an output step of outputting the guidance sound at the set volume level corresponding to the guidance sound stored in the sound volume storing step;
a last-minute guidance sound storing step of storing the output guidance sound; and
a last-minute guidance-sound set-volume changing step of changing a set volume corresponding to the output guidance sound stored in the sound volume storing step.

15. The guidance issuing device of claim 2, further comprising:
a last-minute guidance sound storage unit for storing a guidance sound to be output; and
a last-minute guidance-sound set-volume changing unit for changing a set sound volume corresponding to the output guidance sound stored in the sound volume storage unit.

16. The guidance issuing device of claim 15, wherein
the sound volume storage unit stores a set sound volume to be digitized,
the last-minute guidance-sound set-volume changing unit has a switch for changing a set sound volume, and
the switch changes the digitized set sound volume.

17. The guidance issuing device of claim 15, wherein
the last-minute guidance-sound set-volume changing unit has a rotary switch for changing a volume of a guidance sound supplied from the output unit, and changes a set sound volume in the sound volume storage unit when the rotary switch is operated within a predetermined time of the supply of the guidance sound.

18. The guidance issuing device of claim 15, wherein
when the last-minute guidance-sound set-volume changing unit is continuously operated within a predetermined time, a sound volume set by the sound volume setting unit is not changed.

19. The guidance issuing device of claim 15, wherein
when the last-minute guidance-sound set-volume changing unit is operated during output of the guidance sound, the guidance sound is output at a set volume level.
